(19) United States
(12) Patent Application Publication
(10) Pub. No.: US 2015/0339620 A1
(43) Pub. Date: Nov. 26, 2015

(54) Scheduling Method and System

(71) Applicant: DST Technologies, Inc., Kansas City, MO (US)

(72) Inventors: Deni Esposito, Richmond Hill (CA); Paul Martin Ives, Toronto (CA); Chin Hsu, North York (CA)

(21) Appl. No.: 14/286,384

(22) Filed: May 23, 2014

(51) Int. Cl. G06Q 10/06; G06F 17/30

(52) U.S. Cl. CPC G06Q 10/063116; G06F 17/30477

(57) ABSTRACT

In order to increase the efficiency and flexibility in generating work schedules for employees at an enterprise, a method and a system for generating schedules for users of the system are provided. A database including data records that each include data related to one or more attributes of a respective one of the user is provided. At least one first time period that represents an availability of one of the users is identified. A second time period that is assignable to at least one of the users is identified. The second time period is characterized by attributes. A schedule for the one user is generated based on the data record for the one user, the at least one first time period, and the second time period.

### BACKGROUND

During more challenging economic times, companies may shift from hiring full time employees to hiring part time employees. The use of part time employees by an enterprise, while potentially cost effective for the enterprise, introduces complexities in managing, creating, and distributing work schedules to the part time employees. For example, part time employees with other commitments such as, for example, other jobs, family obligations and/or school may have less regular availability than full time employees. Subsets of these part time employees may have experience and/or skills related to work-related tasks to be completed on a particular day, and correspondingly, particular work-related tasks to be completed on a particular day may require a part time employee with a particular skill set or experience.

As an example, document processing may involve classifying documents into categories (e.g., insurance claims or powers of attorney) and/or confirming that requirements have been met (e.g., a signature is present, a notarization, if required, is present, and/or a medallion stamp, if required, is present). Document processing may also involve the conversion of typed and handwritten text on paper-based and electronic documents into electronic information via manual input or using electronic tools, for example, handwriting recognition software and/or optical character recognition software (e.g., automated document processing). An enterprise that processes documents for a number of different clients (e.g., insurance companies) may employ a large number of part time workers that facilitate the document processing. The workers may categorize the documents, confirm that requirements have been met for the documents, and/or manually enter into a data capture system the typed and handwritten text presented on the paper-based and electronic documents, such as when the automated document processing fails for a particular document.

The workers may each be trained to work with documents for only one client (e.g., a first client or a second client). The documents for the one client, or subsets thereof, may share common characteristics such as the location of document fields or other features, a common format, or otherwise required processing unique to the particular client, for which the worker may be specifically trained. For example, a worker may be trained to perform a set of tasks with regard to all of the documents for the first client. Only a subset of the part time workers, for example, at the enterprise may have the required skill and/or experience to efficiently perform work related tasks for a shift to be scheduled at the enterprise. Each part time worker of this subset of part time workers may have different availability.

One or more supervisors at the enterprise may consider availability of the part time employees and generate a spreadsheet identifying schedules for each of the part time employees at the enterprise. The one or more supervisors may post or distribute the schedules to the part time employees. The supervisor-generated spreadsheet may identify a work schedule for the part time employees at the enterprise for a time period of, for example, three months. Such a supervisor-generated spreadsheet is inflexible and inefficient.

### BRIEF DESCRIPTION OF THE DRAWINGS

The examples of the invention described below can be better understood with reference to the following figures. The components in the figures are not necessarily to scale, emphasis instead being placed upon illustrating the principles of the invention. In the figures, like reference numerals designate corresponding parts throughout the different views.

FIG. 1 shows one embodiment of a system for assigning schedules for workers at an enterprise;

FIG. 2 shows one embodiment of a computer system for use with the system of FIG. 1;

FIG. 3 shows a flow chart of one embodiment of a method for assigning schedules for workers at an enterprise; and

FIGS. 4-10 show screenshots of an exemplary application running on one or more computing devices configured to execute at least a portion of the method of FIG. 3.

### DETAILED DESCRIPTION

In order to increase the efficiency and flexibility in scheduling employees to work at an enterprise, a method and a system for generating, manipulating and assigning schedules to users of the system are provided. A database including data records that each includes data related to one or more attributes of a respective one of the users is provided. At least one first time period that represents an availability of one of the users is identified. A second time period that is assignable to at least one of the users is identified. The second time period is characterized by attributes. A schedule for the one user is generated based on the data record for the one user, the at least one first time period, and the second time period.

The users may be employees or workers at the enterprise and may be full-time, part-time, temporary, contract, freelance, or another type of worker or a combination thereof. The users may also include employees of another enterprise partnered with the enterprise. The system for assigning schedules may be defined by work periods and/or shifts. A work period may be a length of time (e.g., hours, day, week, month) over which work or tasks are to be performed. There may be multiple concurrent and/or consecutive (e.g., broken up by non-work periods) work periods. A shift may be a consecutive portion or subset of a work period during which a single employee works or is otherwise expected or scheduled to perform tasks as described herein.

A database stores data records, each of which includes data related to attributes of a corresponding user of a scheduling system implemented in accordance with the disclosed embodiments. The attributes may include one or more roles of the user within the enterprise, one or more skills of the user, quality statistics and/or other metrics characterizing or otherwise qualifying the user for completing work-related tasks associated with the corresponding user of the scheduling system. The data records may be generated by users of the scheduling system and/or the scheduling system itself. For example, a data record for a first worker may be partly generated by the first worker (e.g., providing data related to skills) and partly generated by a supervisor of the first worker (e.g., providing data related to a role of the first worker within the enterprise). Such data may be transmitted to the database by the first worker and the supervisor of the first worker, respectively, and stored in the database.

At a regular time interval of, for example, once a week, or in response to an event (e.g., an employee at the enterprise quits, a new employee is hired at the enterprise, an employee requests time off or a schedule change occurs, or an employee's skills change), one or more first time periods are identified for and/or by the users of the scheduling system. The one or more first time periods represent time periods for which the users are available to work during a predetermined future period of time (e.g., the following week). For example, the first worker may be available Monday through Friday, 7:00 AM to 5:00 PM, while a second worker may be available Tuesday, 2:00 PM to 8:00 PM, Thursday, 11:00 AM to 4:00 PM, but not available any other days for the week to be scheduled. Additionally or alternatively, the one or more first time periods may represent time periods for which the users are not available. The first time periods (e.g., worker availabilities) may be identified by the users at corresponding computing devices and transmitted to the database. The computing devices may, for example, be mobile devices, and the users may input the worker availabilities via applications running on the mobile devices. The system may allow the user to specify availability in any time increment or time range or may constrain the user to a particular increment or time range (e.g., shifts may only be scheduled in one hour increments that start on the hour). Alternatively or additionally, the worker availabilities may be automatically identified based on worker availabilities submitted for previously generated work schedules. The worker availabilities may be included in or associated with corresponding data records related to the users stored in the database.

At a regular time interval of, for example, every week, or in response to the event, second time periods are identified for the enterprise. The second time periods represent time periods users of the scheduling system are to be assigned to work (e.g., work periods). The enterprise may require a number of hours to be worked by at least some of the users of the scheduling system based on a number of work related tasks to be completed (e.g., 20,000 documents to be processed prior to the end of a week) or based on a target rate of task completion (e.g., 1,000 documents per hour). For example, the enterprise may require 20,000 medical insurance documents to be processed by Thursday of the following week, and the work periods may be defined as Monday through Thursday, 7:00 AM-9:00 PM. The work periods may be identified by supervisors of a subset of the users at corresponding computing devices and transmitted to the database. The computing devices may, for example, be mobile devices, and the supervisors may input the work periods via applications running on the mobile devices. Alternatively or additionally, the work periods may be automatically identified based on work periods submitted for previously generated work schedules or based on the number of work related tasks to be completed. For example, the system may know that 20,000 documents are to be processed in a day and that 1,000 documents may be processed by an average worker at the enterprise in a day (e.g., 9:00 AM to 5:00 PM). The system may identify the work periods based on the number of documents to be processed and the projected output by an average worker at the enterprise (e.g., twenty parallel 9:00 AM to 5:00 PM work periods on the day the 20,000 documents are to be processed). In one embodiment, processing rates for specific workers may be considered by the system when assigning or generating the schedules. In one embodiment, when the processing of a set of documents, for example, is identified as critical (e.g., a service level agreement for production exists), extra work periods may be identified (e.g., extra workers may be scheduled) as a safety margin to ensure that the production goal is met (e.g., 20,000 in a day). Data for the work periods may be stored in the database.

The work periods may be characterized by attributes. For example, the attributes may include a required skill and/or a required role associated with the work periods. The attributes may represent minimum requirements, maximum requirements (e.g., to avoid paying a highly skilled worker for a menial job), or other requirements (e.g., regulatory restrictions such as union requirements, and necessary licenses such as pilot or truck driver licenses) associated with the work periods. For example, the attributes may include a minimum accuracy in preforming the work related tasks associated with the work period (e.g., a minimum accuracy in processing a particular type of document). The work periods may also be identified by the supervisors of the users at the corresponding computing devices and transmitted to the database. The supervisors may input the attributes via the applications running on the mobile devices. Data for the attributes may be stored in the database and associated with corresponding work periods.

Schedules are generated or assigned for the users of the scheduling system based on the data records, the worker availabilities and the work periods. The work periods are compared with the worker availabilities in conjunction with the data records corresponding to the worker availabilities being compared with the attributes of the work periods. In other words, users of the scheduling system are matched with work periods to be scheduled based on matches between worker availability and work periods to be scheduled, and attributes of users and minimum requirements for the work periods to be scheduled. The system uses multidimensional matching to generate or assign schedules for the user of the scheduling system. Schedules may be generated for some or all of the users of the scheduling system at the same time (e.g., once a week, on Sunday). Alternatively, a schedule may be generated for one of the users in response to the one user identifying at least one worker availability. In other words, a user may provide availability to the scheduling system, and the scheduling system may assign work periods (e.g., shifts) to the user in response to receiving the availability from the user. The schedules for the users may be transmitted to the corresponding mobile devices of the user and made available via the applications running on the corresponding computing devices. Alternatively, the schedules may be generated and transmitted to the users via email, for example. With the assigned schedules, the cost of the flexible workforce (e.g., compensation) to the enterprise may be calculated.

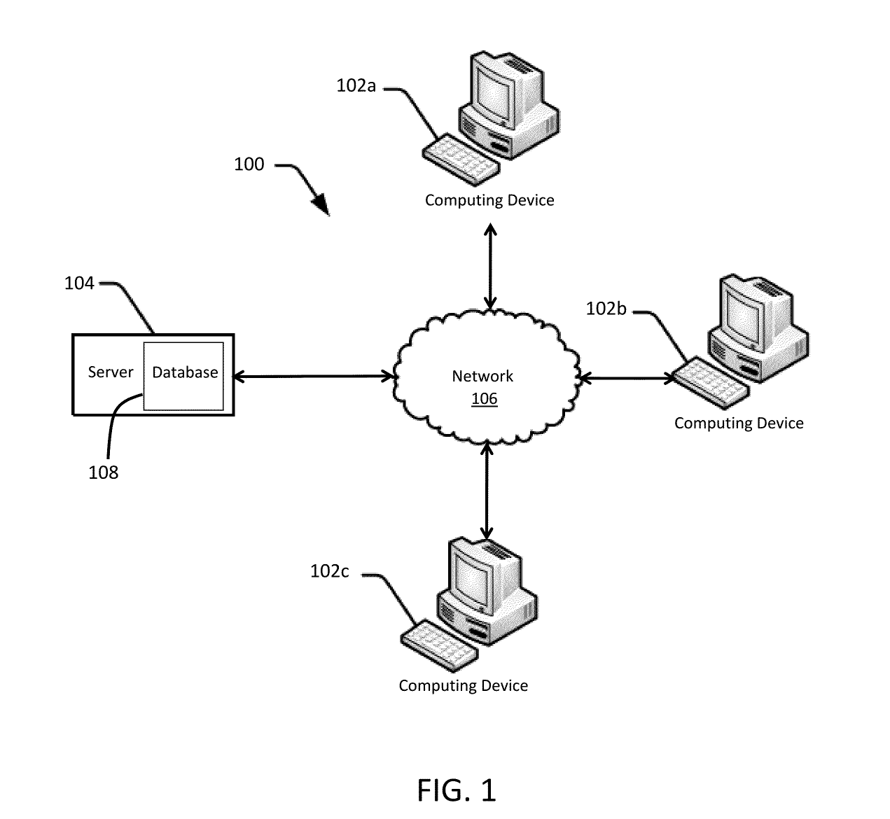

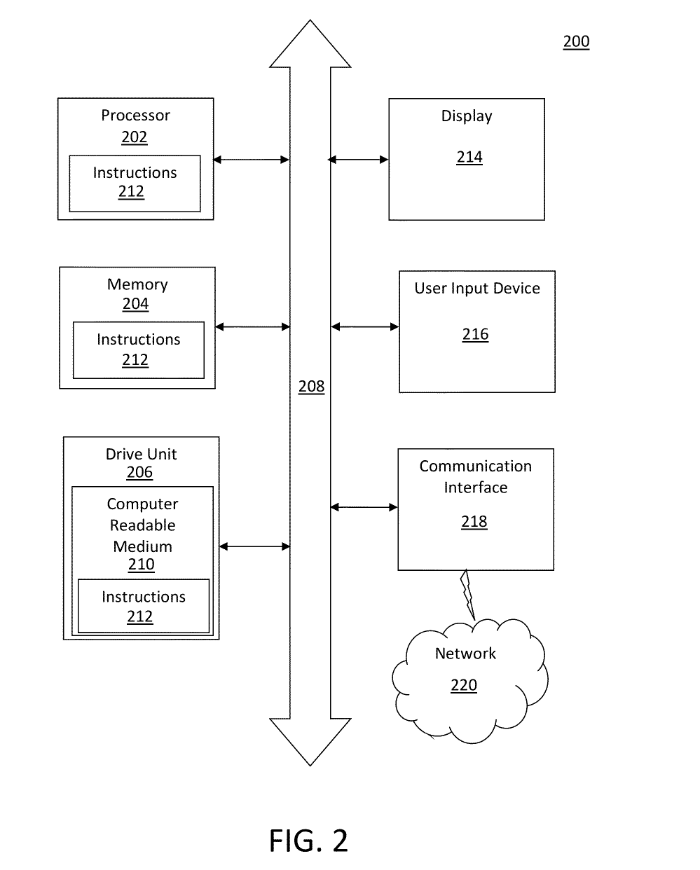

FIG. 1 shows one embodiment of a system 100 for generating schedules for workers at an enterprise. The system 100 includes a plurality of computing devices 102 (e.g., a first computing device 102a, a second computing device 102b, and a third computing device 102c), each of which may be a computing device 200 described below with respect to FIG. 2, in communication with a server 104 via a network 106. The server 104 includes a database 108. Users (e.g., workers at the enterprise) may use the plurality of computing devices 102 to be assigned a work schedule and/or work on work-related tasks. For example, a first worker may use the first computing device 102a, a second worker may use the second computing device 102b, and a third worker may use the third computing device 102c. More than one worker may use the first computing device 102a, the second computing device 102b, and/or the third computing device 102c. For example, the first worker, the second worker, and the third worker may share the first computing device 102a. The system 100 may include more or fewer computing devices 102. Each computing device of the plurality of computing devices 102 and the server 104 may be located in the same or different rooms, the same or different facilities, or the same or different enterprise campuses. In one embodiment, the plurality of computing devices 102 may be operated by a first enterprise, and the server 104 may be operated by a second enterprise. In another embodiment, the workers may be “work at home” workers that use their own computing devices to sign on and take on work-related tasks to perform. To that end, this whole system may be delivered via a web page/site. In other words, the plurality of computing devices 102 may be operated in a first geographic location, and the server 104 may be operated in a second geographic location, where the second geographic location is remote from the first geographic location. The database 108 may be included within the server 104 or may be separate from the server 104. The system 100 may include more databases 108 within the server 104 and/or separate from the server 104. In one embodiment, the system 100 is coupled with an exchange server or a calendar (e.g., Google calendar) to push schedules directly onto a worker's calendar. Meeting invite technology may also be used to determine availability and to seek acceptance of schedule changes.

The database 108 may include a plurality of data records. Each data record of the plurality of data records may include data (e.g., information) related to one or more attributes of a worker at the enterprise. For example, the data may be for a role of the worker within the enterprise and/or one or more skills associated with the worker. In one embodiment, the role of the worker within the enterprise is a document processor, and the one or more skills associated with the worker include types of documents the worker has experience processing (e.g., medical insurance documents). In one embodiment, the data related to one or more attributes of the worker includes data related to quality statistics in processing documents. For example, statistics related to accuracy in processing documents may be generated, maintained, and stored during prior work shifts at the enterprise. Another user (e.g., a supervisor of the worker) may spot check the work done by the worker and generate the data related to quality statistics in processing documents. Alternatively, one or more computing devices of the plurality of computing devices 102, the server 104, one or more other computing devices, or a combination thereof may automatically generate the data related to quality statistics in processing documents. The plurality of data records may include, for example, text files, XML data, image data (e.g., JPEG and/or MPEG), and/or video data. The plurality of data records may include any number of other data types including, for example, data that controls one or more user interfaces of the plurality of computing devices 102 to generate a work schedule for the worker. The plurality of data records may include other information including, for example, historical and future time periods the worker is available to work at the enterprise.

In one embodiment, the plurality of data records may be user-generated. The plurality of data records may be generated by one or more of the workers at least one computing device of the plurality of computing devices 102. In another embodiment, at least some data records of the plurality of data records may be generated by one or more supervisors of the workers. Alternatively or additionally, at least some data records of the plurality of data records may be generated by users at computing devices outside of the system 100 and/or automatically by one or more of the computing devices 102 or one or more other computing devices.

The one or more workers may generate the plurality of data records, for example, by typing or speaking into the at least one computing device 102. The one or more workers may, for example, use a word processing program, a spreadsheet program (e.g., MS Excel) or a separate application running on the at least one computing device 102 to generate some or all data records of the plurality of data records.

The one or more workers may save the plurality of data records to the database 108. A plurality of the workers may collaborate on one data record of the plurality of data records. For example, the first worker may generate the one data record, and the supervisor of the first worker may edit the one data record by changing and/or adding to the one data record (e.g., the supervisor may add or remove roles and/or skills associated with the worker). The one data record may include other information including, for example, the date and time the one data record was created and the date and time the one data record changes and/or additions were made to the one data record.

The system 100 may require authorization from one or more workers to generate and/or edit the plurality of data records. For example, only certain workers with certain roles within the enterprise may generate and/or edit the plurality of data records. The database 108 or another database may include authorization data identifying workers authorized to generate and/or edit the plurality of data records. Each of the one or more workers may input a username and/or a password before saving a generated or edited data record to the database 108. Alternatively or additionally, each of the one or more workers may be identified by an IP address associated with the computing device 102 that the worker uses to generate and/or edit the data record. The server 104 or another computing device may compare the username and/or password to the authorization data stored in the database 108 or the other database to determine if the worker is authorized to generate and/or edit the data record. Each of the one or more workers may be authorized to generate and/or edit some or all data records of the plurality of data records. In one embodiment, before the generated or edited data record may be saved to the database 108, the data record is forwarded to the supervisor of the worker generating and/or editing the data record for review. The generated or edited data record may be automatically forwarded to the supervisor, or the server 104 may prevent the worker from saving the data record to the database 108 until the data record is reviewed. The review helps prevent workers without the required role and/or skills from being scheduled to work on a particular work-related task, thus increasing efficiency and decreasing the cost associated with completing the work-related task.

The server 104 identifies at least one worker availability that represents an availability for a worker of the plurality of workers (e.g., the first worker). The at least one worker availability may represent one or more time periods during which the worker is available to work at the enterprise. The at least one worker availability may represent one or more dates and/or time ranges. Data representing the at least one worker availability may, for example, be textual data representing the at least one worker availability. The data representing the at least one worker availability may be a word, a number, a letter, a symbol, or any combination thereof. The at least one time period may include any number of dates and/or time ranges within a predetermined time period. For example, the at least one time period may be a plurality of dates and corresponding time ranges the first worker, for example, is available to work at the enterprise (e.g., May 5, 2014, 8:30 AM-12:30 PM; May 7, 2014, 11:30 AM-2:30 PM).

In one embodiment, the identification of the at least one worker availability includes the server 104 receiving, from the first worker at the first computing device 102a, for example, the data representing the at least one time period. For example, the first worker may enter the data representing the at least one worker availability into, for example, a graphical user interface of an application running on the first computing device, a word-processing program (e.g., MS Word), or a spreadsheet program (e.g., MS Excel) with an input device (e.g., a touchscreen) of the first computing device 102a (e.g., a mobile device). The first computing device 102a, for example, may send the data representing the at least one time period to the server 104 via the network 106. In some embodiments, the first worker, for example, may send the data representing the at least one worker availability in response to a regularly scheduled inquiry sent by the server 104 or in response to a regularly scheduled pop-up message generated at the first computing device 102a. Alternatively or in addition to receiving the data representing the at least one worker availability related to the first worker from the first worker, the server 104 may receive all or some of the data representing the at least one worker availability related to the first worker from another user (e.g., the supervisor of the first worker) at another computing device. The data representing the at least one worker availability may be stored in the database 108 as part of the data record related to the first worker or separate from but associated with the data record related to the first worker.

In one embodiment, the server 104 may identify the at least one worker availability based on data previously received from the first worker for a prior predetermined time period. In other words, the server 104 may identify the at least one worker availability based on previously received and stored data without additional input from the first worker. For example, the server 104 may receive, from the first worker at the first computing device 102a, data for dates and time ranges during which the first worker may work in the month of May. For the month of June, for example, the server 104 may use the data received for the month of May as the data representing the at least one worker availability.

In another embodiment, the server 104 may identify default data for the at least one worker availability related to the first worker. For example, a new employee (e.g., the first worker) at the enterprise may be required to be available Monday through Friday, 9:00 AM-5:00 PM for the first six months of employment, and the at least one worker availability related to the first worker may be defined by the server 104 without any input from the first worker.

In one embodiment, the plurality of workers may be required to send corresponding worker availabilities to the server 104 prior to the predetermined time period (e.g., the month of May). For example, the plurality of workers may be required to send corresponding work availability to the server 104 during the week before the month to be scheduled. If a worker (e.g., the first worker) of the plurality of workers does not send work availability to the server 104 during the week prior to the month to be scheduled, for example, the server 104 may generate and send one or more messages to the computing device (e.g., computing device 102a) of the first worker to remind the first worker to submit work availability for the month to be scheduled. If the first worker, for example, does not respond to the one or more messages generated by the server 104 with work availability, the server 104 may not include the first worker in the scheduling for the month to be scheduled.

The server 104 identifies a work period. The work period represents a time period to be worked at the enterprise and is assignable to at least one worker of the plurality of workers. The work period is also characterized by attributes. Data for the work period may represent one or more dates (e.g., Tuesday, May 6, 2014) and/or one or more time ranges/durations (e.g., 7:00 AM to 5:00 PM) to which the at least one worker is to be assigned to work. The work period may be associated with a predetermined time period. For example, the work period may be associated with a predetermined week or month. The predetermined time period associated with the at least one worker availability may be the same as the predetermined time period associated with the work period. In other words, the work period may represent a date and time period that at least some workers of the plurality of workers are to be assigned to work in the month of May, for example. In one embodiment, the server 104 identifies a plurality of work periods. The data for the work period may be stored in the database or another database.

In one embodiment, the identification of the work period includes the server 104 receiving, from another worker (e.g., the supervisor of the first worker or a supervisor of the plurality of workers) at another computing device (e.g., the computing device 102b), for example, the data representing the work period. For example, the supervisor of the first worker may enter the data representing the work period into, for example, a graphical user interface of an application running on the other computing device, a word-processing program (e.g., MS Word), or a spreadsheet program (e.g., MS Excel) with an input device (e.g., a touchscreen) of the other computing device (e.g., a mobile device). The other computing device, for example, may send the data representing the work period to the server 104 via the network 106. Alternatively or in addition to receiving the data representing the work period from the other worker, the server 104 may receive all or some of the data representing the work period from one or more additional workers (e.g., additional supervisors) at computing devices. In one embodiment, the server 104 identifies the work period based on work volume data (e.g., a number of documents to be processed). In one embodiment, the work volume data may be identified from a business process management (BPM) solution such as, for example, AWD from DST Systems, Inc. The server 104 may identify 10,000 documents as needing processing, for example, and may identify the work period or a plurality of work periods (e.g., five concurrent works periods Monday through Friday, 9:00 AM to 11:00 PM) estimated to process the 10,000 documents. The server 104 may automatically identify the plurality of work periods once every predetermined time period (e.g., identified once a week for the following week). In such a case, the supervisor may review generated schedules for approval, but may not enter the data representing the work period into the graphical user interface of the application or into Excel, for example. The server 104 may also identify employee performance data (e.g., as part of the data record associated with the worker) from the BPM such as AWD to help increase accuracy when creating a schedule. In one embodiment, the data representing the work period may be stored in the database 108 separate from the plurality of data records.

In one embodiment, the server 104 may identify the work period based on data previously received from the other worker for a prior predetermined time period. In other words, the server 104 may identify the work period based on previously received and stored data without additional input from the other worker. For example, the server 104 may receive, from the other worker at the other computing device, data for dates and time ranges to which the at least one worker is to be assigned to work in the month of May. For the month of June, for example, the server 104 may use the data received for the month of May as the data representing the work period.

In another embodiment, the server 104 may identify default data for the work period. For example, the enterprise may require new employees to work Monday through Friday, 9:00 AM-5:00 PM every week, and the work period may be defined by the server 104 without any input from the other worker.

The server 104 may also identify data related to the work period and associate the data related to the work period with the work period. The data related to the work period may include data related to a description of the work-related tasks to be completed, required experience, a required skill and/or a required role associated with the work period. The identified data related to the required skill and/or the required role associated with the work period may include data related to minimum requirements associated with the work to be completed during the work period. For example, the work to be completed during the work period may relate to a particular type of documentation to be processed (e.g., medical insurance documentation), and the minimum required skill and/or role associated with the work period may relate to the particular type of documentation (e.g., at least two years experience processing medical insurance documentation). As another example, documentation to be reviewed during the work period may be in a foreign language (e.g., Spanish), and the minimum required skill associated with the work period may relate to proficiency in the foreign language (e.g., eight college credits in Spanish or equivalent).

In one embodiment, the data related to the work period includes data related to a minimum quality statistic associated with the work period. The minimum quality statistic may be a minimum accuracy in reviewing documents of the type the work period relates to. For example, for the processing of medical insurance documentation, the minimum accuracy may be set to 99%. Accordingly, a worker of the plurality of workers having an accuracy in processing the medical insurance documentation below 99% may not be scheduled to work the work period.

The identification of the data related to the work period includes the server 104 receiving, from the other worker at the other computing device, for example, the data related to the work period. For example, the other worker may enter the data related to the work period (e.g., the data related to the required skill and/or the required role associated with the work period and/or the data related to the minimum quality statistic associated with the work period) in a graphical user interface of an application running on the other computing device, a word-processing program (e.g., MS Word), or a spreadsheet program (e.g., MS Excel) with an input device (e.g., a touchscreen) of the other computing device (e.g., a mobile device). The other computing device, for example, may send the data related to the work period to the server 104 via the network 106. Alternatively or in addition to receiving the data related to the work period from the other worker, the server 104 may receive all or some of the data related to the work period from one or more additional workers (e.g., additional supervisors) at computing devices. The data related to the work period may be stored in the database 108 separate from the plurality of data records. In one embodiment, the data related to the work period may be stored in the database and associated with the data representing the work period.

In one embodiment, the server 104 may automatically identify at least a portion of the data related to the work period based on data previously stored in the database 108. For example, the server 104 may receive, from the other worker at the other computing device, data related to the work period that identifies the work period as relating to processing medical insurance documentation. Based on the received data related to the work period, the server may identify minimum requirements previously used in scheduling based on other data stored in the database.

The server 104 generates a schedule for the first worker based on the data record related to the first worker, the identified at least one worker availability, and the identified work period. The schedule may be automatically generated for the first worker in response to the reception, from the first worker, of the data identifying the at least one worker availability during which the first worker is available to work at the enterprise, or the schedule may be generated for each worker of the plurality of workers at the same time, on a regular basis. For example, the server 104 generates a schedule for each worker of the plurality of workers once a week or once a month.

In one embodiment, the server 104 compares the at least one worker availability during which the first worker is available to work at the enterprise with the identified work period, and compares the data related to the one or more attributes of the first worker (e.g., the role of the first worker within the enterprise, the data related to the one or more skills associated with the first worker, and/or the data related to the quality statistics for the first worker) with the data related to the work period (e.g., the required experience, the required skill and/or the required role associated with the work period). In one embodiment, if the work period is included entirely within the at least one worker availability (e.g., the at least one worker availability includes 7:00 AM to 5:00 PM on Tuesday, May 6, 2014, and the work period includes 9:00 AM to 12:00 PM on Tuesday, May 6, 2014), and the data related to the one or more attributes of the first worker matches or exceeds the minimum requirements defined by the data related to the work period (e.g., the data related to the one or more attributes of the first worker specifies the first worker as having two years experience processing medical insurance documents and having 99% accuracy in processing the medical insurance documents, and the data related to the work period specifies minimum requirements of one year experience processing the medical insurance documents and 98% accuracy in processing the medical insurance documents), the server 104 identifies the first worker as a candidate worker. In other embodiments, the work period does not have to be included entirely within the at least one worker availability to be considered a match. For example, a 90% percent overlap (e.g., the at least one worker availability overlaps with 90 minutes of a 100 minute shift defined by the work period) may be considered a match. Other percentages may be used.

The comparisons are conducted for each worker of the plurality of workers, for a number of different work periods identified by the server 104. Accordingly, the server 104 may identify a subset of workers of the plurality of workers as candidate workers for each work period identified by the server 104. The server may assign the work period to a most qualified worker of the subset of workers (e.g., the first worker). The server 104 may compare attributes of the subset of workers (e.g., as defined by the data related to the one or more attributes of the plurality of workers) to determine the most qualified worker of the subset of workers (e.g., the worker of the candidate workers with the highest accuracy in processing documents), the cheapest worker of the subset of workers, or the worker of the subset of workers with the greatest document processing rate. In one embodiment, the server 104 may consider other factors when determining which worker of the subset of workers is to be assigned the work period. For example, the other factors may include how many hours the worker is already scheduled to work during the predetermined time period (e.g., the month of May), how many hours the worker is already scheduled to work on any given day (e.g., Tuesday, May 6, 2014), or any other factors that may affect productivity.

In one embodiment, the server 104 may optimize the assignment of schedules, such that cost to the enterprise is minimized, while minimum requirements for the work periods are also met. In another embodiment the server 104 may store exceptions to the requirements defined by the data related to the work period. For example, the data related to a plurality of work periods to be worked in parallel may identify a minimum required experience. The data related to the plurality of work periods may also include an exception to the minimum required experience, allowing workers with less than the minimum required experience to be assigned to some work periods of the plurality of work periods when a supervisor with a minimum required experience is assigned to one of the work periods. The system may utilize the exception when the available workers do not meet the minimum required experience, for example. In yet another embodiment, the system may monitor the rate of work being completed to predict whether a goal is going to be met. If the goal is not going to be met, the system may assign emergency shifts for later in the day (e.g., after 4:00 PM), for example, to attempt to meet the goal. The emergency shifts may be assigned to workers on call, and/or one or more workers may be offered the emergency shifts in exchange for an incentive (e.g., a monetary incentive).

After the work periods identified by the server have been assigned to the plurality of workers, schedules are generated and/or assigned for at least some workers of the plurality of workers (e.g., workers to which work periods have been assigned).

For example, the information corresponding to the assigned work periods (e.g., assigned shifts) may be presented to the first worker via a graphical user interface at the first computing device. The information corresponding to the assigned shifts may, for example, be presented to the first worker in a pop-window within the graphical user interface at the first computing device. The information corresponding to the assigned shifts may be presented to the first worker in any number of forms including, for example, in calendar form. In one embodiment, the server 104 generates the schedule and transmits the generated schedule to the first worker via e-mail.

In one embodiment, if a scheduled worker calls in sick or otherwise cancels a scheduled work period (e.g., a scheduled shift), the server 104 may automatically assign the canceled shift to the next most qualified worker of the subset of workers. Alternatively, the next most qualified worker may be offered an incentive for agreeing to schedule the canceled shift.

The system may reassign schedules to accurately meet the work needs (e.g., to meet a production goal) and to minimize cost at the enterprise. A cancellation of a scheduled work period may have a ripple effect. For example, if lower level workers were scheduled based on the scheduling of a more experienced supervisor who has called in sick, the system may require an equally experienced or sufficiently experienced replacement to supervise the scheduled lower level workers (e.g., as defined by the data related to the work period). If equally experienced or sufficiently experienced replacements are not available based on identified worker availabilities, the system may offer an incentive to one or more sufficiently experienced workers, and may assign the canceled shift to the first sufficiently experienced worker to accept the incentive. As another example, if a highly productive worker (e.g., processes more documents per day than the average worker at the enterprise) becomes unavailable, the system may offer replacement worker(s) the cancelled shift based on document process rate(s) associated with the replacement worker(s). In such a situation, the data related to the work period may identify a document process rate, for example, necessary to meet the production goal. A single replacement worker that is highly productive (e.g., with a document process rate equal to or greater than the worker who cancelled the shift) may be offered the cancelled shift with an incentive before offering the cancelled shift to multiple less productive workers working in parallel (e.g., to compensate for the unavailable highly productive worker). The system may minimize costs to the enterprise when reassigning cancelled shifts.

In one embodiment, when no worker availabilities defined by the plurality of workers match a work period required to be worked at the enterprise, the sever 104 may generate a message to the most qualified worker (e.g., having the highest quality percentage, having the most experience, whether the worker is registered, licensed, an/or bonded, has security clearance or a minimum level of security clearance, has necessary worker citizenship, is not subject to export controls, or a combination thereof), for example, requesting acceptance of scheduling the work period. In other words, when none of the workers are available to work a shift defined by the work period, the server may identify a qualified worker (e.g., the first worker), based on the minimum requirements associated with the work to be completed during the work period, and generate a message to the qualified worker requesting acceptance of scheduling the work period. The message may include a description of a predetermined incentive (e.g., a monetary incentive or paid time off) if the scheduling of the work period is accepted. The message may be transmitted from the server 104 to the first worker, for example, at the first computing device via the network 106. The first worker may respond to the message (e.g., yes or no) via a graphical user interface at the first computing device, and the work period may be assigned to the first worker, for example, based on the return message generated by the first worker.

The system may balance the amount of work needed to get done, the availability of the workers and the limitations on the hours a worker may work (e.g., before being paid at an overtime rate) to appropriately staff a project. In other words, the system may optimize a work schedule for the enterprise. In one embodiment, labor distribution to a global workforce may be optimized. The system may be used to adjust offshore daily, weekly, or monthly schedules for employees of the enterprise, for example. The cost to the enterprise (e.g., compensation for the workers) may be minimized. For example, a higher number of cheaper overnight workers may be hired to compensate for a lower number of workers during the day.

FIG. 2 shows an illustrative embodiment of a general computer system 200. The computer system 200 may include a set of instructions that may be executed to cause the computer system 200 to perform any one or more of the methods or computer based functions disclosed herein. The computer system 200 may operate as a standalone device or may be connected (e.g., using a network) to other computer systems or peripheral devices. Any of the components discussed above may be a computer system 200 or a component in the computer system 200.

In a networked deployment, the computer system 200 may operate in the capacity of a server or as a client user computer in a client-server user network environment, or as a peer computer system in a peer-to-peer (or distributed) network environment. The computer system 200 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In one embodiment, the computer system 200 may be implemented using electronic devices that provide voice, video or data communication. Further, while a single computer system 200 is illustrated, the term “system” shall also be taken to include any collection of systems or sub-systems that individually or jointly execute a set, or multiple sets, of instructions to perform one or more computer functions.

As illustrated in FIG. 2, the computer system 200 may include a processor 202 such as, for example, a central processing unit (CPU), a graphics-processing unit (GPU), or both. The processor 202 may be a component in a variety of systems. For example, the processor 202 may be part of a standard personal computer or a workstation. The processor 202 may be one or more general processors, digital signal processors, application specific integrated circuits, field programmable gate arrays, servers, networks, digital circuits, analog circuits, combinations thereof, or other now known or later developed devices for analyzing and processing data. The processor 202 may implement a software program, such as code generated manually (i.e., programmed).

The computer system 200 may include a memory 204 that may communicate via a bus 208. The memory 204 may be representative of the database 108. The memory 204 may be a main memory, a static memory, or a dynamic memory. The memory 204 may include but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 204 includes a cache or random access memory for the processor 202. In alternative embodiments, the memory 204 is separate from the processor 202, such as a cache memory of a processor, the system memory, or other memory. The memory 204 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 204 is operable to store instructions executable by the processor 202. The functions, acts or tasks illustrated in the figures or described herein may be performed by the programmed processor 202 executing the instructions stored in the memory 204. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 200 may further include a display unit 214, such as a liquid crystal display (LCD), an organic light emitting diode (OLED), a flat panel display, a solid state display, a cathode ray tube (CRT), a projector, a printer or other now known or later developed display device for outputting determined information. The display 214 may act as an interface for the user to see the functioning of the processor 202, or specifically as an interface with the software stored in the memory 204 or in a disk or optical drive unit 206 (e.g., a disk drive unit).

Additionally, the computer system 200 may include an input device 216 configured to allow a user to interact with any of the components of system 200. The input device 216 may be a number pad, a keyboard, or a cursor control device, such as a mouse, or a joystick, touch screen display, remote control or any other device operative to interact with the system 200.

In one embodiment, as depicted in FIG. 2, the computer system 200 may also include the disk or optical drive unit 206. The disk drive unit 206 may include a computer-readable medium 210, in which one or more sets of instructions 212 (e.g., software) may be embedded. Further, the instructions 212 may embody one or more of the methods or logic as described herein. In one embodiment, the instructions 212 may reside completely, or at least partially, within the memory 204 and/or within the processor 202 during execution by the computer system 200. The memory 204 and the processor 202 also may include computer-readable media as discussed above.

The present disclosure contemplates a computer-readable medium that includes instructions 212 or receives and executes instructions 212 responsive to a propagated signal, so that a device connected to a network 220 may communicate voice, video, audio, images or any other data over the network 220. Further, the instructions 212 may be transmitted or received over the network 220 via a communication port 218. The communication port 218 may be a part of the processor 202 or may be a separate component. The communication port 218 may be created in software or may be a physical connection in hardware. The communication port 218 is configured to connect with the network 220 or another network, external media, the display 214, any other components in system 200, or combinations thereof. The connection with the network 220 may be a physical connection, such as a wired Ethernet connection or may be established wirelessly as discussed below. Likewise, the additional connections with other components of the system 200 may be physical connections or may be established wirelessly.

The network 220 may include wired networks, wireless networks, or combinations thereof, and may be representative of the network 106. The wireless network may be a cellular telephone network, an 802.11, 802.16, 802.20, or WiMax network. Further, the network 220 may be a public network, such as the Internet, a private network, such as an intranet, or combinations thereof, and may utilize a variety of networking protocols now available or later developed including, but not limited to TCP/IP based networking protocols.

While the computer-readable medium is shown to be a single medium, the term “computer-readable medium” includes a single medium or multiple media (e.g., a centralized or distributed database and/or associated caches and servers that store one or more sets of instructions). The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium may include a solid-state memory such as a memory card or other package that houses one or more non-volatile read-only memories. Further, the computer-readable medium may be a random access memory or other volatile re-writable memory. Additionally, the computer-readable medium may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In one embodiment, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limiting embodiment, implementations may include distributed processing, component/object distributed processing, and parallel processing. Alternatively, virtual computer system processing may be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

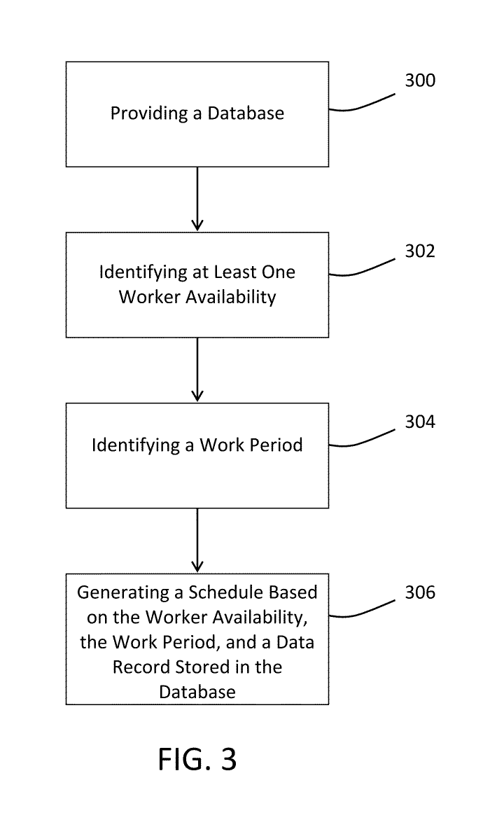

FIG. 3 shows a flowchart of one embodiment of a method for assigning schedules for a plurality of users of a scheduling system (e.g., a plurality of workers). The method may be performed using the system 100 shown in FIG. 1 or another system. The method is implemented in the order shown, but other orders may be used. Additional, different, or fewer acts may be provided. Similar methods may be used for presenting generating schedules.

The method includes providing a database including a plurality of data records (act 300). Each data record of the plurality of data records includes data related to one or more attributes of a worker of the plurality of workers. The data related to the one or more attributes of the worker (e.g., a first worker) includes data related to a role of the worker within an enterprise and/or data related to one or more skills associated with the worker. In one embodiment, the data related to the one or more attributes of the worker also includes data related to quality statistics for the worker.

The database may be part of or separate from a server. The server may be in communication with a plurality of computing devices via a network. The first worker may interact with a first computing device of a plurality of computing devices (e.g., provide inputs at the first computing device). The first worker may generate at least a portion of the data record related to the first worker via the first computing device and/or other computing devices of the plurality of computing devices. In one embodiment, another worker (e.g., a supervisor of the first worker) may generate some or all of the data record related to the first worker. The generated data records may be transmitted to the server, for example, and stored in the database. The first worker and/or the other workers may update the generated data records. The updates may replace the generated data records, supplement the generated data records, or a combination thereof.

At least one worker availability is identified (act 302). In one embodiment, the server identifies the at least one worker availability. The at least one worker availability represents an availability for the first worker, for example. Data for the at least one worker availability may represent one or more dates and/or one or more time ranges during which the first worker is available to work at the enterprise. The at least one worker availability may be associated with a predetermined time period. For example, the at least one worker availability may be associated with a predetermined week or month. The data for the at least one worker availability may be stored in the database or another database. In one embodiment, the data for the at least one worker availability is part of the data record related to the first worker.

In one embodiment, the identification of the at least one worker availability includes the server receiving, from the first worker at the first computing device, for example, the data representing the at least one worker availability. The first computing device, for example, may send the data representing the at least one worker availability entered by the first worker at the first computing device to the server via the network. Alternatively or in addition to receiving the data representing the at least one worker availability from the first worker, the server may receive all or some of the data representing the at least one worker availability from one or more other workers at other computing devices. The data representing the at least one worker availability may be stored in the database as part of the data record related to the first worker or separate from the data record related to the first worker. In one embodiment, the server may identify the at least one worker availability based on data previously received from the worker for a prior predetermined time period.

A work period is identified (act 304). In one embodiment, the server identifies the work period. The work period represents a time period to be worked at the enterprise, is assignable to at least one worker of the plurality of workers and is characterized by attributes. Data for the work period may represent one or more dates and/or one or more time ranges the at least one worker is to be assigned to work. The work period may be associated with a predetermined time period. For example, the work period may be associated with a predetermined week or month. The data for the work period may be stored in the database or another database.

In one embodiment, the identification of the work period includes the server receiving, from another worker at the other computing device, for example, the data representing the work period. The other computing device, for example, may send the data representing the work period to the server via the network. Alternatively or in addition to receiving the data representing the work period from the other worker, the server may receive all or some of the data representing the work period from one or more additional workers (e.g., additional supervisors) at computing devices. The data representing the work period may be stored in the database separate from the plurality of data records. In one embodiment, the server may identify the work period based on data previously received from workers (e.g., the other worker) for a prior predetermined time period.

The server may also identify data related to the work period. The data related to the work period may include data related to a description of the work-related tasks to be completed, required experience, a required skill and/or a required role associated with the work period. The identified data related to the required skill and/or the required role associated with the work period may include data related to minimum requirements associated with the work to be completed during the work period.

In one embodiment, the data related to the work period includes data related to a minimum quality statistic associated with the work period. The minimum quality statistic may be a minimum accuracy in completing the work-related tasks.

The identification of the data related to the work period includes the server receiving, from the other worker at the other computing device, for example, the data related to the work period. The other computing device, for example, may send the data related to the work period to the server via the network. Alternatively or in addition to receiving the data related to the work period from the other worker, the server may receive all or some of the data related to the work period from one or more additional workers (e.g., additional supervisors) at computing devices. The data related to the work period may be stored in the database separate from the plurality of data records. In one embodiment, the data related to the work period may be stored in the database with the data representing the work period.

The server generates a schedule for the first worker based on the data record related to the first worker, the at least one worker availability, and the work period (act 306). In one embodiment, the schedule is automatically generated for the first worker in response to the reception, from the first worker, of the data identifying the at least one worker availability during which the first worker is available to work at the enterprise. In another embodiment, a schedule is generated for each worker of the plurality of workers on a regular basis. For example, the server generates a schedule for each worker of the plurality of workers once a week or once a month. The server may generate the schedules for the plurality of workers at the same time.

In one embodiment, the server compares the at least one worker availability during which the first worker is available to work at the enterprise with the identified work period, and compares the data related to the one or more attributes of the first worker (e.g., the role of the first worker within the enterprise, the data related to the one or more skills associated with the first worker, and/or the data related to the quality statistics for the first worker) with the data related to the work period (e.g., the required experience, the required skill and/or the required role associated with the work period). In one embodiment, if the work period is included entirely within the at least one worker availability, and data related to the one or more attributes of the first worker matches or exceeds the minimum requirements defined by the data related to the work period, the server identifies the first worker as a candidate worker. In other embodiments, the work period does not have to be included entirely within the at least one worker availability to be considered a match.

The comparisons are conducted for each worker of the plurality of workers, for a number of different work periods identified by the server. Accordingly, the server may identify a subset of workers of the plurality of workers as candidate workers for each work period identified by the server. The server may assign the work period to a most qualified worker of the subset of workers. The server may compare attributes of the subset of workers to determine the most qualified worker of the subset of workers. In one embodiment, the server may consider other factors when determining which worker of the subset of workers is to be assigned the work period.

After the work periods identified by the server have been assigned to the plurality of workers, schedules are generated for at least some workers of the plurality of workers. For example, the information corresponding to the assigned shifts may be presented to the first worker via a graphical user interface at the first computing device. For example, the information corresponding to the assigned shifts may be presented to the first worker in a pop-window within the graphical user interface at the first computing device. The information corresponding to the assigned shifts may be presented to the first worker in any number of forms including, for example, in calendar form. In one embodiment, the server generates the schedule and transmits the generated schedule via e-mail.

In one embodiment, when no worker availabilities defined by the plurality of workers match a work period required to be worked at the enterprise, the sever may generate a message to the most qualified worker, for example, requesting acceptance of scheduling the work period. The message may include a description of a predetermined incentive if the scheduling of the work period is accepted. The message may be transmitted to the first worker, for example, at the first computing device via the network. The first worker may respond to the message via a graphical user interface at the first computing device, and the work period may be assigned to the first worker, for example, based on the return message generated by the first worker.

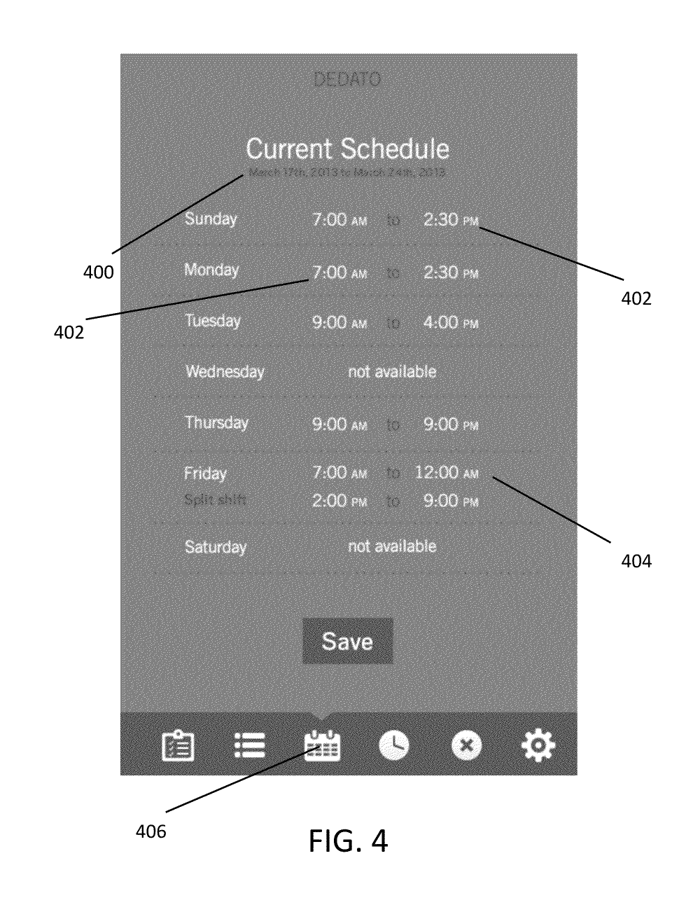

FIGS. 4-10 show screenshots of an exemplary application running on one or more computing devices (e.g., the computing device 102a) configured to execute at least a portion of the method of FIG. 3 or another method. DEDATO™ is the name of an exemplary application implemented in accordance with the disclosed embodiments. The computing device may, for example, be a mobile device with a touchscreen input.

As shown in FIG. 4, the application may display a current schedule assigned to a user of the computing device. The current schedule may be for a predetermined time period 400 such as, for example, one week (e.g., Mar. 17, 2013 to Mar. 24, 2013). The work start time and end time 402 scheduled for the predetermined time period 400 may be displayed for each date of the week, for example. Days for which the worker is not available or is not scheduled to work may be identified as “not available” (e.g., see Wednesday in FIG. 4). When the worker is scheduled to work two separate blocks of time on a single day, two sets of start times and stop times may be identified as a “split shift” (e.g., see Friday in FIG. 4, elements 404). The worker may view the current schedule assigned to the worker within the application by selecting a current schedule icon 406 within the application.

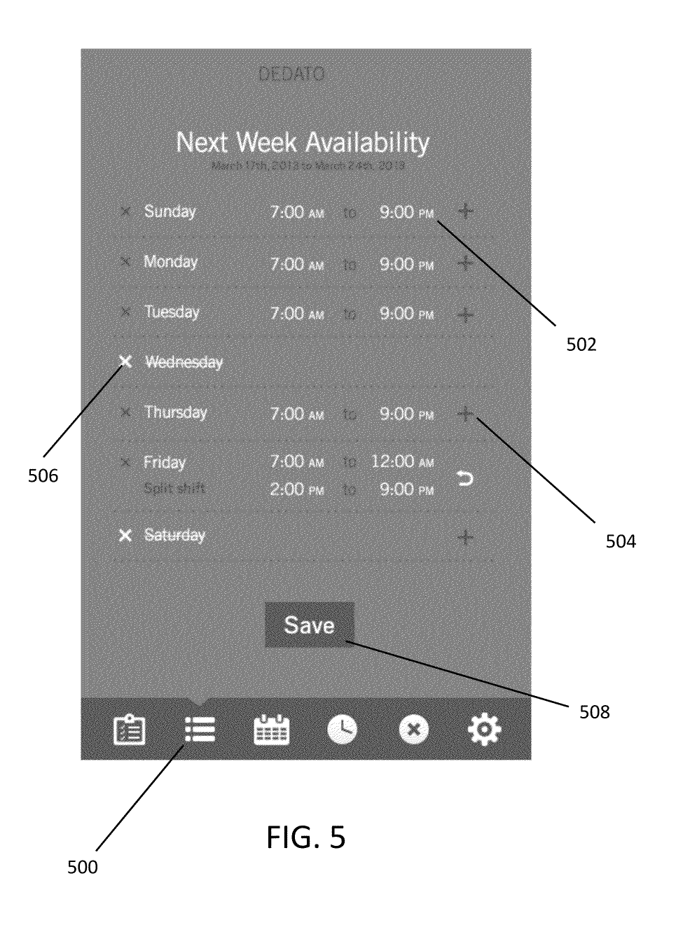

As shown in FIG. 5, the worker may select a worker availability icon 500 to define time periods for which the worker is available to work. The application may define a range of dates for which data may be input by a worker (e.g., Sunday through Saturday of the following week). For example, the application may accept data representing availability for a future time period (e.g., the following week) from the worker once a week (e.g., every Tuesday). The application may notify the worker (e.g., via text message, via an audio signal, via a banner message on the computing device, or via email) when the data representing availability is to be input.

The worker may input data representing availability into data fields 502 via the touchscreen. The worker may input data representing start times and end times to define time periods for which the worker is available to work on corresponding days. The worker may define multiple time periods for each day (e.g., 7:00 AM-12:00 AM, 2:00 PM-9:00 PM, Friday). The worker may select a split shift icon 504 (e.g., a plus symbol) to define the multiple time periods for the day. The worker may select an icon 506 (e.g., an “x”) representing unavailability for a particular day (e.g., see Wednesday and Saturday in FIG. 5). Once the worker selects the icon 506, the corresponding day may be struck through to visually indicate that the worker cannot work on the corresponding day. Once the worker has completed entering data into the data fields 502, the worker may select the “SAVE” button 508 within the application. Once the “SAVE” button 508 is selected, the inputted data may be sent to a server (e.g., the server 104) via a network. Alternatively, the inputted data may be saved locally at the computing device and accessed by the server or forwarded to the server at a later time. The inputted data may be editable up until a specified cutoff date, or a specified cutoff date and time (e.g., the Friday before the work week to be scheduled, at noon).

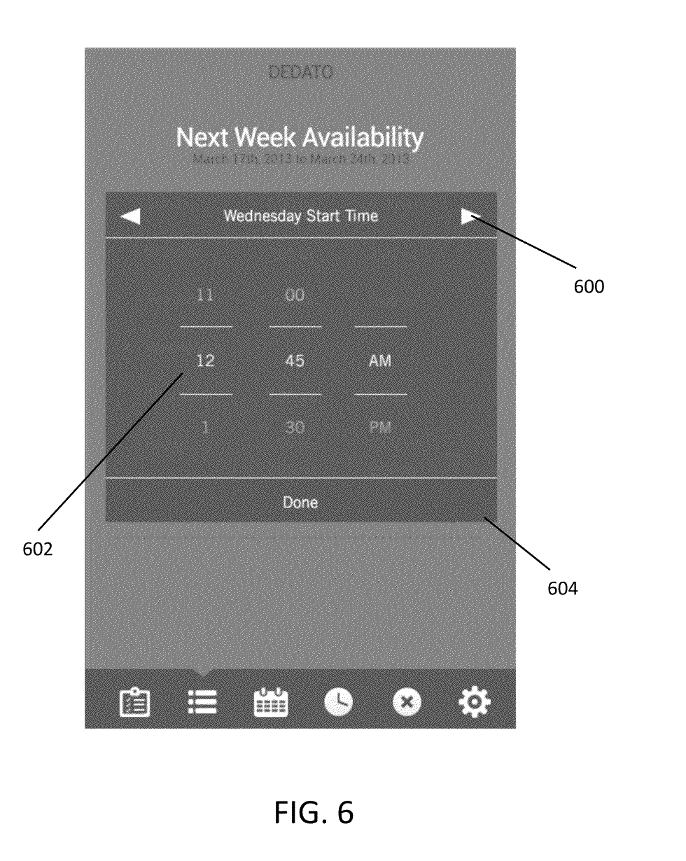

As shown in FIG. 6, once the worker selects a data field 502, the worker may define the start time or the end time corresponding to the data field 502 within the application. Forward and backward arrows 600, for example, allow the worker to toggle between the data fields 502 of FIG. 5, for example. The worker may swipe data fields 602 up or down to define the hour, the minutes, and the time of day, respectively. Different intervals may be provided for the different data fields 602. For example, the interval for the hour may be one hour, the interval for the minutes may be fifteen minutes, and the time of day may be AM or PM. Different data input interfaces may be provided within the application (e.g., text input). The worker may select an icon 604 (e.g., a button including the word “Done”) to indicate that input of the start time or the end time, for example, is complete.

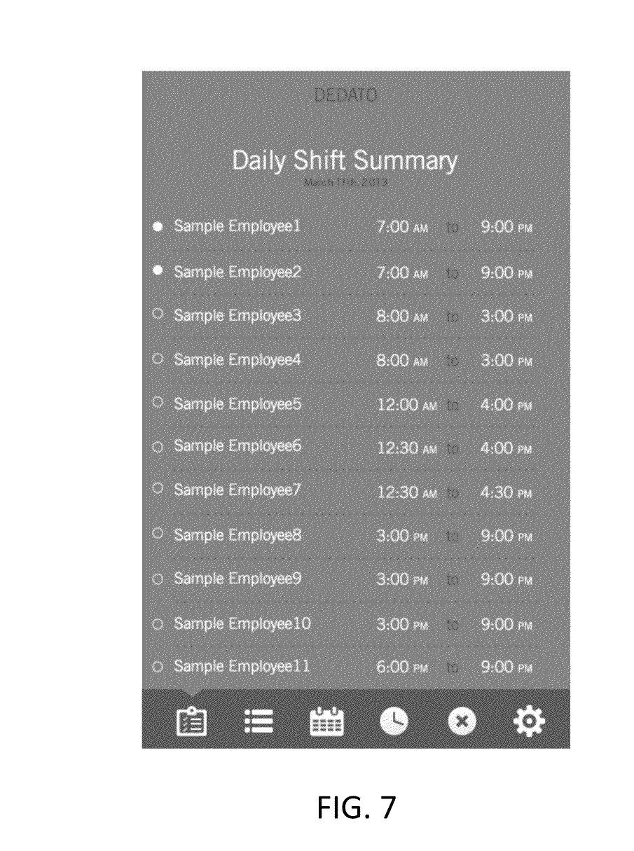

A supervisor may define available work periods using similar interfaces to the interfaces shown in FIGS. 5 and 6. The supervisor may define the available work periods within an application running on another computing device. The supervisor may also identify the cutoff date or the cutoff date and time within the application running on the other computing device. Once the supervisor has input available work periods and workers have input worker availabilities for the future time period, the server, for example, assigns shifts to some or all of the workers. FIG. 7 shows an exemplary display within the application running on the computing device of the supervisor. Assigned shifts and corresponding workers assigned the shifts are displayed to the supervisor.

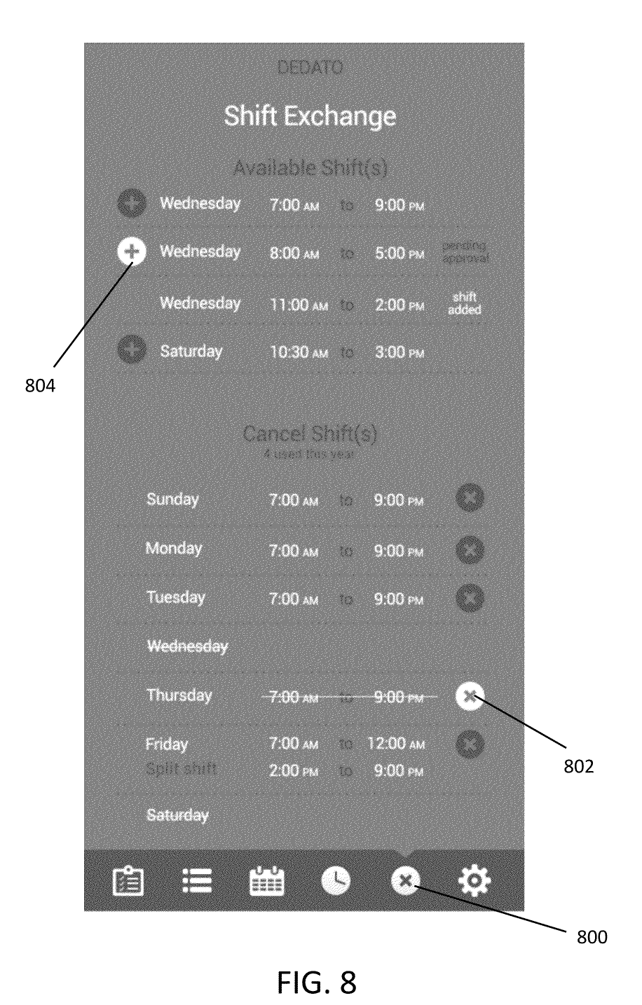

As shown in FIG. 8, the worker may select a cancel shift icon 800 to access a shift cancel portion of the application. Within the shift cancel portion of the application, the worker may select a button 802 (e.g., including the letter “X”) to cancel a corresponding shift. Once the worker selects the button 802, the cancellation may be initiated and may be indicated within the graphical user interface by strikethrough of the corresponding shift. In one embodiment, the worker may finalize the cancellation by selecting a button (e.g., including “Submit to Manager”) that will initiate notification of the supervisor that the worker is attempting to cancel the shift. If the worker attempts to cancel a shift within a predetermined time period (e.g., 48 hours) of the start time of the shift, the worker may have to call the supervisor. In such a case, the application may display the phone number for one or more supervisors of the worker. The application may identify, within the shift cancel portion of the application, for example, how many vacation days and/or sick days the worker has used (e.g., four shown in the example of FIG. 8) within a predetermined time period (e.g., the current fiscal year for the enterprise).

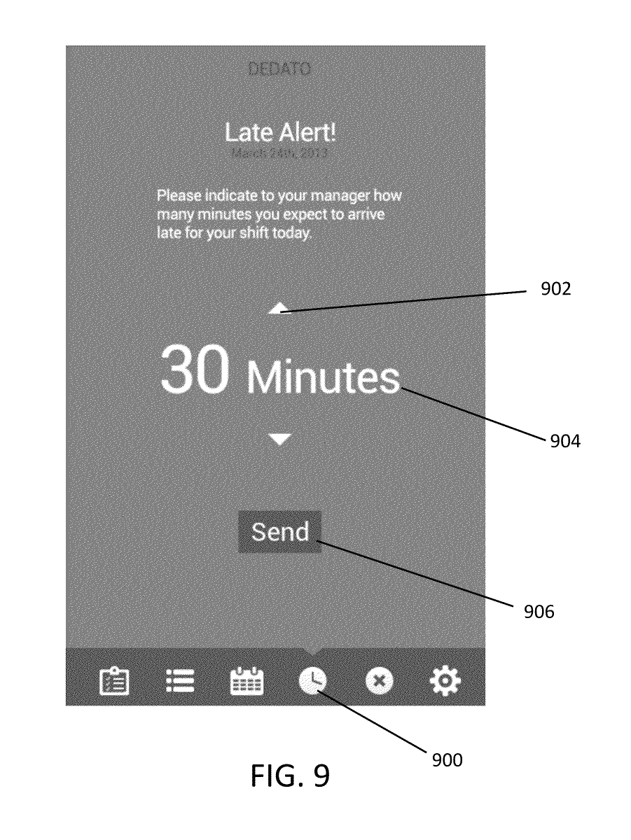

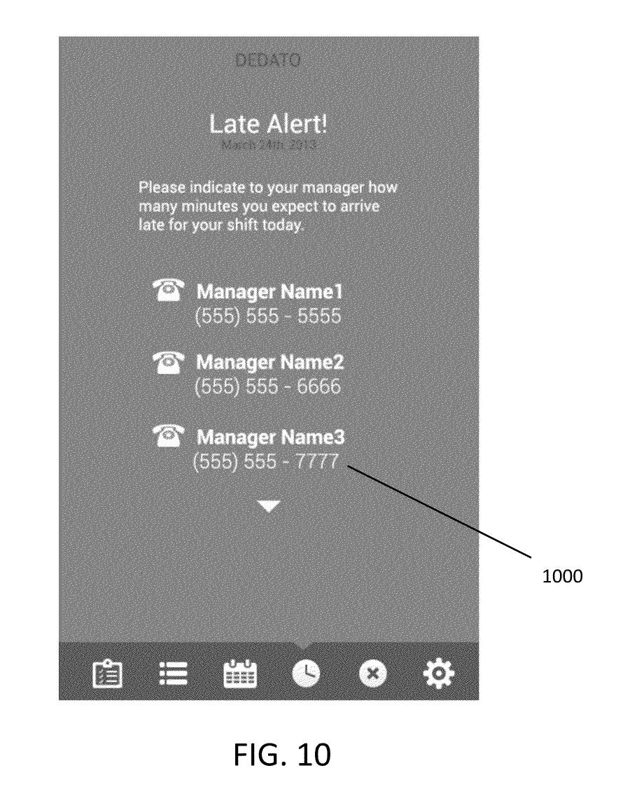

As shown in FIG. 9, the worker may select a late alert icon 900 within the application to notify the supervisor, for example, that the worker is going to be late for a shift. The worker may use arrows 902 to indicate how late the worker will be for the shift. The arrows 902 may change an amount of time 904 by a predetermined time interval such as, for example, five minutes. A predetermined maximum amount of time may be set within the application. For example, the arrows 902 may change the amount of time 904 from zero minutes to 60 minutes at an interval of five minutes. Other intervals and other maximum amounts of time may be provided within the application. If the worker attempts to set the amount of time 904 to be greater than the predetermined maximum amount of time, the application may display contact information for one or more supervisors (see FIG. 10). Once the appropriate amount of time 904 is set (e.g., 30 minutes), the worker may select a send button 906 within the application to initiate communication of the amount of time the worker is going to be late to the shift to the supervisor. The worker may input data into the application in different ways (e.g., text entry into the application).

FIG. 10 shows an example display within the application after the worker has attempted to select an amount of time 904 the worker is going to be late to the shift that is greater than the predetermined maximum amount of time (e.g., sixty minutes). The application displays contact information 1000 (e.g., a name and a phone number) for one or more supervisors (e.g., three supervisors). The worker may select the displayed phone number for one of the supervisors to call the supervisor with the computing device.

As shown in FIG. 8, the worker may exchange a shift with another worker within the shift cancel portion of the application. Once the worker cancels a shift within the shift cancel portion of the application (e.g., the shift scheduled for Thursday in FIG. 8), the worker may add an available shift (e.g., cancelled by the other worker) to make up for the canceled shift. In one embodiment, the worker may be required to add an available shift before the worker may cancel a shift. The server may automatically exchange the shifts cancelled by the worker and the other worker, respectively, based on corresponding availability. In one embodiment, once the worker cancels the shift, the server may automatically reassign the shift to another worker without requiring the worker to add the available shift. Alternatively, the reassignment may require acceptance by the worker and/or the other worker. The application may notify the worker that the worker has been assigned a cancelled shift. The worker may select an add button 804 (e.g., represented by a “+”) to add an available shift. Incentives (e.g., a bonus) for accepting a cancelled shift may also be identified and displayed within the application.

The application may notify a worker, via a corresponding mobile device, for example, that a schedule has been assigned to the worker, the assigned schedule has been changed, when a shift is going to start and/or end, or a combination thereof. A computing device (e.g., a mobile device) configured to run the application implementing the method of FIG. 3, for example, improves accuracy in the assignment of work to qualified workers at the enterprise and may decrease costs to the enterprise.

The application may provide a number of functions outside of the method of FIG. 3, for example. Training materials and references related to the tasks to be completed during the assigned shifts may be available for the worker to access via the application. This allows the worker to access the training materials and references outside of work. Other information may be made available to the worker via the application. For example, the worker may be able to access corporate procedures and mandates, dress code policies, travel allowances, and other information related to the enterprise via the application. In another example, the worker may be able to access a map of the office. The map may show fire exits and routes to the exits during an emergency. Location data generated or received at the computing device may be used to determine a location of the worker relative to the fire exit. The application may change the pitch and/or volume of an alarm the closer the worker is to the fire exit.

In one embodiment, a customized call tree may be accessible via the application. The application may store or access a worker/manager organization tree. The customized call tree may allow the worker to easily call or message a supervisor (e.g., a manager). Emergency contact information may be self maintained, stored and visible for all workers within the application. In one embodiment, an icon within the application may be selectable by the worker to alert a group within the customized call tree that a medial emergency has occurred. A location of the emergency may be input within the application, or the application may use location data generated or received by the computing device. The data representing the location of the emergency may be transmitted with the alert. The group may be identified within the customized call tree as having first aid qualifications. In other embodiments, the selectable icons may be for other types of emergencies such as, for example, a fire. In the case of such an emergency, the application may play predetermined audio data. The audible alarm may be a sound such as a beep or may convey information as to the type of emergency (e.g., where to go after exiting the building during a fire). The worker may be able to check in, using the application, once the worker is safely outside of the building.

In one embodiment, the application may include a panic button the worker may select to silently turn on voice and video recording and call 911. For example, if the worker is being attacked (e.g., while at work), the worker may select the panic button within the application running on the computing device to record the attack and call for help.

In one embodiment, video recordings using the computing device may be broadcast to some or all of the other users of the application. For example, the worker may broadcast a medical emergency to indicate the medical personnel needed. Also, the worker may broadcast video of a robbery in progress, a fire situation to help fire fighters before they arrive on the scene, or another event. The video may be streamed via a server to a live display for assessment and may be stored locally at the computing device and/or at the server or the cloud. In one embodiment, the video or information in a different format (e.g., text data) may be provided anonymously.

The application may be integrated with enterprise level systems. For example, scheduling provided by the application may be integrated with timekeeping software. In another example, some or all of the features described above, along with the assignment of shifts described above, may be integrated with an internal social network such as, for example, the social network described in U.S. Patent Publication No. 2013/0304763, which is hereby incorporated by reference in its entirety.

In one embodiment, the application is integrated with the worker's Facebook page. For example, other workers may be notified via Facebook when the worker cancels a shift. Also, shift exchange and work place location detection may be provided via the worker's Facebook page.

Data collected during use of the application may be used to issue rewards to the worker, for example. The data collected may include data representing, for example, a number of shifts cancelled, a number of shifts for which the worker was late, and other information. The application may issue rewards to the worker based on the collected data. For example, the worker may receive a coupon for a free lunch or another reward when the worker is on time to work every work day for a month.

In one embodiment, the application may run on a computing device (e.g., a laptop or desktop computer) on which work is completed by the worker. The application may track the number of hours worked by the worker during a predefined period of time (e.g., a week) and may automatically log the worker off the computing device or a software program run on the computing device when a predetermined maximum number of hours to be worked is reached (e.g., so the worker falls within part time employee rules and regulations). The application may allow the worker to complete a task (e.g., review of a document) before logging the worker off of the computing device.

The application may notify the worker when a shift becomes available (e.g., when another worker cancels a shift), and the worker is qualified to work the shift. The notification may be a text message, a pop-up message displayed at the computing device, an email message, or another type of notification. The canceled shift may be automatically reassigned to the worker, or the worker must accept the reassignment. In one embodiment, the application may use location data provided by the computing device to determine whether or not to provide notifications to the worker when shifts are cancelled and available for assignment to the worker. For example, if the worker is on vacation in Europe and works in the United States, the application may not provide notifications to the worker based on the location data indicating the computing device is located in Europe.

The application may analyze the data representing the assigned schedules to determine how many workers and at what time workers are working. This analysis may be used for cross-marketing purposes. For example, the enterprise (e.g., a construction company) may provide a partner of the enterprise (e.g., a mobile business such as a food or coffee truck) the analysis (e.g., how many people are working during lunch of a workday), such that the mobile business may identify whether there are enough customers in the area being targeted (e.g., a construction worksite).

In one embodiment, a payment device (e.g., a credit card reader) may be connected to the computing device, and the worker may be paid for his or her work via the payment device. For example, the worker may swipe a reloadable prepaid credit card through the credit card reader connected to the computing device once a week to be paid for that week's completed work.

In one embodiment, the application may track workers of the application. For example, near field communications (NFC) may be generated and sent with the computing device (e.g., using radio-frequency identification (RFID) technology within the computing device). The NFC may be used to transfer data to readers located at doors within buildings of the enterprise, for example, to access parts of the buildings and open the doors. The NFC may also be used to check in and out of work (e.g., via a wireless network). The application may handshake with a server on a local WIFI network to identify that the worker is at the office. The computing device may thus replace security badges worn by employees.

Tracked data related to the location of the worker may be used to reimburse a worker (e.g., a traveling salesperson) for mileage reimbursement. The mileage reimbursement may be paid to the worker using, for example, the payment device connected to the computing device. In one embodiment, the tracked data and/or the generated work schedule may be used to alert the worker when a shift starts and/or ends, and/or when a break starts and/or ends. For example, the application may generate and output a sound via the computing device when a shift is to begin.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is therefore intended that the foregoing detailed description be regarded as illustrative rather than limiting, and that it be understood that it is the following claims, including all equivalents, that are intended to define the spirit and scope of this invention.

We claim:

1. A computer implemented method for assigning schedules to a plurality of users, the method comprising:
providing, by a processor, a database stored in a non-transitory memory coupled with the processor and including a plurality of data records, each data record of the plurality of data records including data related to one or more attributes of a user of the plurality of users;
identifying, by the processor, at least one first time period for which a user of the plurality of users is available to work;
identifying, by the processor, a second time period for which a user of the plurality of users is needed to work, the second time period being characterized by attributes needed of a user to work during the second time period;
assigning, by the processor, a schedule to the user based on a comparison of the data record with the attributes characterizing the second time period, and a comparison of the at least one first time period with the second time period.

2. The computer implemented method of claim 1, wherein the data related to the one or more attributes of the user comprises data related to a role of the user within an enterprise, data related to one or more skills associated with the user, or data related to the role of the user within the enterprise and the one or more skills associated with the user.

3. The computer implemented method of claim 2, wherein identifying the at least one first time period comprises receiving, from the user, data identifying at least one first time period during which the user is available to work at the enterprise.

4. The computer implemented method of claim 3, wherein the assigning comprises automatically assigning the schedule to the user in response to the receiving, from the user, of the data identifying the at least one first time period during which the user is available to work at the enterprise.

5. The computer implemented method of claim 4, further comprising:
identifying data related to a required skill, a required role, or the required skill and the required role associated with the second time period; and
comparing the at least one first time period during which the user is available to work at the enterprise with the identified second time period, and comparing the data related to the role of the user within the enterprise, the data related to the one or more skills associated with the user, or the data related to the role of the user within the enterprise and the one or more skills associated with the user with the data related to the required skill, the required role, or the required skill and the required role associated with the second time period,
wherein assigning the schedule to the user comprises generating the schedule based on the comparisons.

6. The computer implemented method of claim 5, wherein identifying the data related to the required skill, the required role, or the required skill and the required role associated with the second time period comprises identifying data related to minimum requirements associated with the second time period.

7. The computer implemented method of claim 5, further comprising generating a message including a request for acceptance of scheduling the second time period and a description of an incentive for the user when, based on the comparisons, the at least one first time period during which the user is available to work at the enterprise does not match with the identified second time period, but the data related to the role of the user within the enterprise, the data related to the one or more skills associated with the user, or the date related to the role of the user within the enterprise and the one or more skills associated with the user match the data related to the required skill, the required role, or the required skill and the required role associated with the second time period.

8. The computer implemented method of claim 7, wherein the generated message includes an incentive-based offer for accepting scheduling of the second time period.

9. The computer implemented method of claim 7, further comprising receiving, from the user, data responsive to the generated message, the data responsive to the generated message representing acceptance or rejection of the incentive-based offer,
wherein assigning the schedule comprises assigning the schedule to the user based on the data responsive to the generated message.

10. The computer implemented method of claim 1, wherein the data related to the one or more attributes comprises data related to quality statistics for the user, and
wherein the method further comprises identifying data related to a minimum quality statistic associated with the second time period.

11. The computer implemented method of claim 10, wherein the data related to the minimum quality statistic associated with the second time period comprises data representing an accuracy percentage in completing a task associated with the second time period.

12. The computer implemented method of claim 1, wherein identifying the second time period comprises receiving, from another user of the scheduling system, the data identifying the second time period, the second time period representing a time period during which one user of the plurality of users is to work at an enterprise.

13. In a non-transitory computer-readable storage medium having stored therein data representing instructions executable by a programmed processor for automatically assigning schedules to a plurality of users in response to inputs from the plurality of users, the instructions comprising:
storing, in a database, a plurality of data records, each data record of the plurality of data records including data related to one or more attributes of a user of the plurality of users;
identifying at least one first time period, the at least one first time period representing an availability for a user of the plurality of users;
identifying a second time period, the second time period being assignable to at least one user of the plurality of users, the second time period being characterized by attributes;
assigning a schedule to the user based on a comparison of the data record with the attributes characterizing the second time period, and a comparison of the at least one first time period with the second time period.

14. The non-transitory computer-readable storage medium of claim 13, wherein the data related to the one or more attributes of the user comprises data related to a role of the user within an enterprise, data related to one or more skills associated with the user, or data related to the role of the user within the enterprise and the one or more skills associated with the user.

15. The non-transitory computer-readable storage medium of claim 14, wherein identifying the at least one first time period comprises receiving, from the user, data identifying at least one first time period during which the user is available to work at the enterprise.

16. The non-transitory computer-readable storage medium of claim 15, wherein the assigning comprises automatically assigning the schedule for the user in response to the receiving, from the user, the data identifying the at least one first time period during which the user is available to work at the enterprise.

17. The non-transitory computer-readable storage medium of claim 15, wherein the instructions further comprise:
identifying data related to a required skill, a required role, or the required skill and the required role associated with the second time period; and
comparing the at least one first time period during which the user is available to work at the enterprise with the identified second time period, and comparing the data related to the role of the user within the enterprise, the data related to the one or more skills associated with the user, or the data related to the role of the user within the enterprise and the one or more skills associated with the user with the data related to the required skill, the required role, or the required skill and the required role associated with the second time period,
wherein assigning the schedule for the user comprises assigning the schedule based on the comparisons.

18. A system for generating schedules for a plurality of users of the system, the system comprising:
a database including a plurality of data records, each data record of the plurality of data records including data related to one or more attributes of a user of the plurality of users; and
a processor in communication with the database and configured to:
identify at least one first time period, the at least one first time period representing an availability for a user of the plurality of users;
identify a second time period, the second time period being assignable to at least one user of the plurality of users, the second time period being characterized by attributes; and
generate a schedule for the user based on a comparison of the data record with the attributes characterizing the second time period, and a comparison of the at least one first time period with the second time period.

19. The system of claim 18, wherein the data related to the one or more attributes of the user comprises data related to a role of the user within an enterprise, data related to one or more skills associated with the user, or data related to the role of the user within the enterprise and the one or more skills associated with the user.

20. The system of claim 19, wherein the identification of the at least one first time period comprises receipt, from the user, of data identifying at least one first time period during which the user is available to work at the enterprise,
wherein the processor is further configured to:
identify data related to a required skill, a required role, or the required skill and the required role associated with the second time period; and
compare the at least one first time period during which the user is available to work at the enterprise with the identified second time period, and compare the data related to the role of the user within the enterprise, the data related to the one or more skills associated with the user, or the data related to the role of the user within the enterprise and the one or more skills associated with the user with the data related to the required skill, the required role, or the required skill and the required role associated with the second time period, and
wherein generation of the schedule for the user comprises generation of the schedule based on the comparisons.

21. A system for assigning schedules to a plurality of users of the system, the system comprising, the system comprising a processor and a memory coupled with the processor, the system further comprising:
a database including a plurality of data records, each data record of the plurality of data records including data related to one or more attributes of a user of the plurality of users; and
first logic stored in the memory and executable by the processor to identify at least one first time period, the at least one first time period representing an availability for a user of the plurality of users;
second logic stored in the memory and executable by the processor to identify a second time period, the second time period being assignable to at least one user of the plurality of users, the second time period being characterized by attributes; and
third logic stored in the memory and executable by the processor to assign a schedule to the user based on a comparison of the data record with the attributes characterizing the second time period, and a comparison of the at least one first time period with the second time period.
